(19) United States
(12) Patent Application Publication
(10) Pub. No.: US 2008/0166940 A1
(43) Pub. Date: Jul. 10, 2008

(54) MULTI-LAYER NONWOVEN COMPOSITE MATERIAL AND METHOD OF MANUFACTURE

(75) Inventors: KAYREN JOY NUNN, Bixby, OK (US); Bradley R. Tate Nunn, Glenpool, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(73) Assignee: Sustainable Solutions, Inc., Wagoner, OK (US)

(21) Appl. No.: 11/941,762

(22) Filed: Nov. 16, 2007

Related U.S. Application Data
(60) Provisional application No. 60/859,737, filed on Nov. 16, 2006.

(51) Int. Cl. B32B 5/26

(52) U.S. Cl. 442/346

(57) ABSTRACT

A multi-layer nonwoven composite material includes base layers which impart desired properties. The number of base layers can vary as desired for desired properties in order to tune the resulting multi-layer composite material. In a preferred composite material, three base layers are provided to impart sound deadening, sound dispersion, sound absorption, and sound durability. The base layers are first produced from constituent fibers to form constituent webs. These webs are then combined into a multi-layer substrate. A barrier layer may be applied to the multi-layer substrate to impart additional properties. A face layer may be adhered to form a multi-layer nonwoven composite material. The barrier material imparts fire retardancy water resistance while the face carpet imparts cosmetic and/or tactile qualities. Other materials, such as chemical additives, can be applied to the composite material to achieve desired characteristics.

### FIELD OF THE INVENTION

The present invention relates to the manufacture of a multi-layer nonwoven composite material and specifically, the manufacture of a multi-layer reduced weight nonwoven composite material wherein which each layer displays unique properties.

### BACKGROUND OF THE INVENTION

Nonwoven fabrics, which can be made relatively inexpensively by a variety of methods, are widely used in applications requiring a low cost, durable material. In addition, processes have been developed to employ regenerated scrap materials back into usable nonwoven materials. This has the benefit of reducing the huge volume of textile and other fibrous scrap, and particularly synthetic fibrous scrap, that was historically been discarded in landfills. However, there has historically not been a great demand for such materials and particularly not in the volume that eliminates scrap being discarded in landfills. In fact, the amount of such scrap materials discarded continues to rise in spite of attempts at regeneration of such materials.

Some processes which incorporate regenerated scrap materials construct multi-layers of nonwovens which typically include one or more layers of virgin/staple materials mechanically secured to one or more layers of materials derived from regenerated scrap fibers. However, these multi-layered composite materials include fibers that are substantially similar in composition, length, and denier range. A need, therefore, exists for a multi-layer nonwoven composite material which is engineered to employ substantially dissimilar constituent fibers.

Certain applications, and particularly in the automotive industry, require materials which are lightweight, durable and impart advantageous qualities such as sound or heat insulation. It has proven very difficult to produce such materials with the desired qualities at an economical price. As a result, materials satisfying all of these requirements are usually reserved for higher priced vehicles. A need, therefore, exists for a material which possesses these desired characteristics which can be produced at an economical price for use in lower priced vehicles but yet also possess the physical (cosmetic and tactile) qualities required for higher priced vehicles.

Most present carpet systems for automotive or commercial use are not designed specifically to absorb sound. Although they may inherently absorb some sound, the carpet system is not designed for this purpose. In addition, present carpet systems are not designed for eventual recycle. As a result, many undesirable chemicals are added, particularly for flame retardant and/or stain resistance purposes, which make their way, ultimately, into landfills. A need, therefore, exists for a material specifically designed for sound reduction and eventual disassembly so as to be regenerated into other quality products.

### SUMMARY OF THE INVENTION

The present disclosure relates to a multi-layer nonwoven composite material. In addition, the present disclosure relates to the manufacture of a such a multi-layer nonwoven composite material. The multi-layer nonwoven composite material as disclosed herein has a benefit of reduced weight and ease of installation on an acoustic substrate. In addition, each layer of the multi-layer reduced weight nonwoven composite material displays unique properties which may be specifically selected for and thereby contribute to the characteristics of the composite material as a whole. As a result, the multi-layer nonwoven composite material may be tuned so as to display desired characteristics. Such properties may include, but are not limited to, sound deadening, sound absorption, sound dispersion, durability, antibacterial, fire retardancy and odor absorption.

The multi-layer substrate may incorporate regenerated fibers in order to utilize these otherwise discarded fibers in the construction of a high quality, aesthetically pleasing composite system. The high quality composite system may be used in the construction of automotive carpets, linings, and acoustic materials. It may also be used in commercial or residential construction, particularly where a durable material is required which also deadens or otherwise reduces sound transmission. Such applications are useful in hotels, hospitals, theaters, office buildings, and the like.

The multi-layer composite is also designed for disassembly. This means that the material is designed to be recycled or regenerated into new products. This is because the constituent fibers are known and can be easily separated for recycle. Moreover, chemicals and other materials commonly added to carpet and/or carpet padding, including rubber, petroleum based and/or volatile organic compounds are eliminated.

The multi-layer nonwoven composite material of the present disclosure includes base layers which impart desired properties. The number of base layers can vary as desired for desired properties/characteristics of the resulting composite material. In a preferred composite material, three base layers are provided. A first layer includes a blend of coarse natural and synthetic fibers, such as a blend of nylon and polyester and/or polypropylene. The purpose of the first layer in a preferred arrangement is for sound deadening.

The second base layer of the composite material in a preferred arrangement includes a blend of various microdenier (less than one) synthetic fibers such as nylon, aramid, and/or paraaramids. The purpose of this second layer is for sound dispersion.

The third base layer of the composite material in a preferred arrangement includes a blend of various multi-denier synthetic and natural fibers. The purpose of the third layer is to absorb sound and durability. The third layer may include blend such as cotton and polyester.

In a preferred arrangement, three base layers are included as a part of the multi-layer nonwoven composite material disclosed herein. These three base layers of the preferred arrangement impart the characteristics of sound deadening, sound dispersion, sound absorption, and durability. It should be understood, however, that additional layers in the base layers are contemplated and could be added as additional characteristics are desired. Specifically, it is contemplated that a barrier layer may be included to impart fire (flame) retardancy and/or water resistance. Although the number of layers of the base layers is not critical, factors which relate to the number chosen include cost of manufacture, product cost, weight and thickness of the resulting final composite material.

In the manufacturing process of the present disclosure, the three base layers are first produced. The respective fibers of each base layer are blended in a blending step at a plurality of blending stations in a blending step. In a preferred arrangement, the blending step is accomplished by mixing each of the constituent base fibers in a separate blendline box and then each is respectively conveyed to a carding station to form a constituent web in an aggregating step. These constituent webs form the respective base layers of the multi-layer nonwoven composite material.

In a combining step, the respective constituent webs are conveyed to a combining station where the respective constituent webs are combined into a multi-layer (a tri-layer in the preferred arrangement) substrate. In the preferred arrangement, the combining step is accomplished through the use of a needle loom.

The multi-layer substrate is then conveyed to an adhesive station. At the adhesive station, adhesive material is applied in an adhesive step to the multi-layer substrate.

Following application of adhesive, a face layer may be applied. The adhesive acts to fuse the face layer to the multi-layer base substrate to form a multi-layer nonwoven composite material. The face layer can be any desired finished carpet, for example comprised of natural, synthetic, or a blend of natural and synthetic fibers, that supplies the desired cosmetic and/or tactile qualities to the multi-layer nonwoven composite material. In addition, other materials, such as chemical additives, can be applied to the finished composite material to achieve desired characteristics such as odor absorption, antibacterial, durability, stain resistance, etc.

It is an object of the present disclosure to define a multi-layer nonwoven composite material which can be tuned wherein each layer imparts a different property and/or characteristic to the composite.

An additional object of the present disclosure is to define a multi-layer nonwoven composite material which is lightweight and cost effective to manufacture.

It is another object of the present disclosure to define a process for manufacture of a multi-layer nonwoven composite material.

It is a further object of the present disclosure to employ reclaimed or regenerated fibers from post-industrial scrap into the manufacture of a multi-layer nonwoven composite material.

Other and further objects will be hereinafter described and more particularly delineated in the appended claims.

### BRIEF DESCRIPTION OF THE DRAWINGS

FIG. 1 depicts a flowchart of a process for opening and cutting post-industrial scrap fibers.

FIG. 2 depicts a preferred process diagram for the manufacture of a multi-layer nonwoven composite material of the present disclosure.

FIG. 3 depicts a typical carding apparatus.

FIG. 4 is a flow-chart depicting the process for manufacture of a multi-layer composite material of the present disclosure.

### DETAILED DESCRIPTION OF THE PREFERRED EMBODIMENT

The present invention relates to a multi-layer nonwoven composite material and to the manufacture of a such a multi-layer nonwoven composite material. The composite material of the present disclosure may be manufactured from virgin fibers, fibers recovered from post-industrial scrap, or most preferably, a combination of both. The use of post-industrial fibers reduces the industrial waste stream and the volume of such scrap material being deposited in landfills and the like. In addition, the use of post-industrial regenerated fibers reduces the cost of manufacture of the nonwoven composite material thereby making it an attractive alternative to competitive technologies.

With reference to Table I, the component layers of the preferred multi-layer nonwoven composite material shall next be described. In the preferred construction multi-layer composite material of the present disclosure, three base layers are provided. Each base layer of the multi-layer reduced weight nonwoven composite material displays unique properties which may be specifically selected for and thereby contribute to the characteristics of the composite material as a whole. As such, by selecting base layers for their unique properties, the resultant multi-layer composite can be tuned for the specific application and its desired or required properties. In the preferred embodiment, the base layers of the multi-layer nonwoven composite material impart the characteristics of sound deadening, sound dispersion, sound absorption, water resistance durability. The constituent fibers of the base layers are accordingly selected so as to impart these characteristics.

TABLE I

| Layer | Materials | Properties |
|---|---|---|
| 5 | Face Layer - Various | Cosmetic, Odor Absorption, |
| | Natural/Synthetic Fibers | Tactile |
| 4 | Barrier Layer | Adhesion Fire Retardancy, |
| | Polymeric Film | Water Resistance |
| 3 | Various Multi-Denier | Durability, Sound |
| | Synthetic Fibers | Absorption |
| 2 | Various Micro Denier | Sound Dispersion |
| | Synthetic Fibers | |
| 1 | Various Coarse Denier | Sound Deadening |
| | Natural/Synthetic Fibers | |

Layer 1, the first base layer includes a blend of coarse natural and synthetic fibers, such as a blend of cotton and polyester (51/49) and/or polypropylene. The purpose of the first layer in a preferred arrangement is for sound deadening. The constituent fibers of the first base layer may be virgin fibers or fibers reclaimed from scrap materials. In the preferred embodiment, these fibers are derived from opened and cut post-industrial scrap materials. Since reclaimed scrap fibers are employed, the cost of materials is reduced over the use of virgin fibers. As a result, since materials costs are lower, the increased cost of additional processing resulting from the addition of multi-layers balances out. However, a superior composite material finished product, imparting specific, unique properties, results.

For the purpose of the preferred embodiment of the present disclosure, the coarse denier synthetic fibers include a range of between 100 and 2000. The third base layer of the preferred embodiment made from constituent coarse denier fibers would impart durability to the finished multi-layer nonwoven composite material.

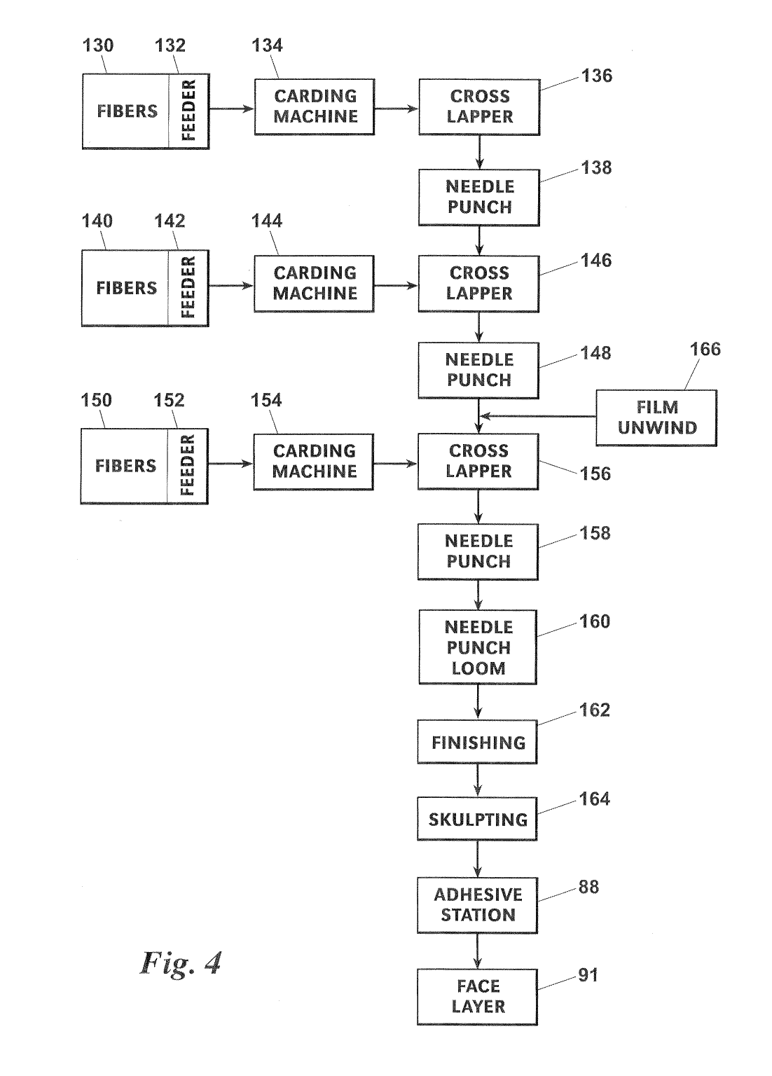

Layer 2 (FIG. 4), the second base layer of the composite material in the preferred arrangement, includes a blend of various microdenier synthetic fibers. The purpose of this second layer is for sound dispersion. As with the first base layer, the fibers forming the constituent web of the second base layer may be either virgin fibers or reclaimed from scrap materials. In the preferred embodiment, the fibers of the second base layer are reclaimed from post-industrial scrap.

For the purpose of the present disclosure, the term microdenier refers to synthetic fibers with a denier per filament (dpf) of less than 1.5. The preferred microdenier synthetic fibers in the present disclosure are of a dpf of between 0.5 and 1.5.

Since these microdenier synthetic fibers are extremely fine, the constituent fibers can be packed closely together in a constituent web. A constituent web base layer formed at the carding station of the aggregating step (as described above) from these fibers can be oriented such that, sound absorbed by layer 1 and transmitted to layer 2 can be dispersed in a transverse direction rather than passing through to layer 3 thus further contributing to the sound insulating characteristics of the finished multi-layer nonwoven composite material.

Layer 3, the third base layer of the composite material in a preferred arrangement includes a blend of various multi-denier synthetic fibers. The purpose of the third layer is to impart durability and further sound absorption to the composite material since denier. As with the first and second base layers, the constituent fibers of the third base layer may be derived from virgin fibers or from regenerated scrap material. In the preferred embodiment, the constituent fibers of the third base layer are derived from regenerated post-industrial scrap opened and cut as described above. An antibacterial agent may be applied (sprayed onto) layer 3.

Layer 4 of the preferred multi-layer nonwoven composite material defined contained in Table I is a barrier layer. The barrier layer 4 may contribute to fire (flame) retardancy, repel water, or provide structural support to the resultant multi-layer nonwoven composite material.

Layer 5 of Table I, the face layer, can be any desired finished carpet, for example comprised of natural, synthetic, or a blend of natural and synthetic fibers, that supplies the desired cosmetic and/or tactile qualities to the multi-layer nonwoven composite material 94. The face layer is preferably manufactured from a blend of virgin fibers including wool, polyester, and nylon, however, face layers manufactured from regenerated fibers or other types of fiber could be equally suitable.

An adhesive material/layer can be used to bond the face layer (layer 5, Table I), if one is used, to the multi-layer composite. In some embodiments, a reinforcing layer (described below) may itself be an adhesive, for example, a polyolefin scrim, in which case, no adhesive is necessary. When an adhesive is necessary, as in the presence of a face layer, the adhesives can be in the form of a sheet, a scrim, a powder, a liquid, a curable composition, and the like. When provided in liquid form, they can be applied using a variety of methods, for example, knife coating, spray coating, employing a doctor blade, and the like. The adhesives can be curable, such as urethanes, acrylates, epoxies, thermoset, thermoplastic, such as ethylene vinyl acetate (EVA), polyvinyl chloride (PVC) plastisols, and polyolefins, such as polypropylene and polyethylene, hot-melt, pressure-sensitive adhesives, and rubber cement. The adhesive formulations can be 100% solids (i.e., all of the components of the composition are UV-curable, so there are no volatile emissions), water-based, or solvent-based.

A preferred multi-layer composite material is thus described. However, it is understood that additional layers could be added in order to further tune the resultant composite material so as to impart additional properties.

If the multi-layer composite material of the present invention is to be used for subfloors or flooring applications, one or more cushioning layers may be desired, as a layer on the top or the bottom of the product. The cushioning layer(s) allows the product to have properties, such as softness and resiliency. In addition to providing resiliency, the cushioning layer can provide additional functions such as enhancing the acoustic properties and/or conformability.

In addition to a cushioning layer, if the multi-layer composite material of the present invention is to be used for subfloors or flooring applications without a finish layer, an anti-skid layer may be adhered to the top and/or the bottom of the product. The anti-skid layer(s) allows the product to have the property of increased friction. If the anti-skid layer is applied as a top layer to the multi-layer composite, it will provide the property of increased friction with the traffic, most commonly foot traffic, on the surface of the product so as to reduce the possibility of slips/falls. If the anti-skid layer is applied as a bottom layer to the multi-layer composite, it will also impart the property of increased friction, however, in this case to reduce the possibility that the product will slide on the surface on which it is applied. It is contemplated that a anti-skid layer could be applied both to the top and bottom surface of the multi-layer composite. Such anti-slip materials are known in the art, however, rubber, and most particularly regenerated rubber are most preferred.

In some embodiments, it is desirable to apply a reinforcing layer to the multi-layer composite material. This reinforcing layer can be present inside the multi-layer product if it is applied as the material is being formed, such as between adjacent layers or it can be applied to the top and/or bottom of the resulting multi-layer composite.

The reinforcing layer can be any material that reinforces the composite sufficiently for its desired end use. Examples include scrims, wovens, knits, non-wovens, solid sheets, films, foams, and the like. These layers can be formed from synthetic or organic fibers, fiberglass, plastics, metals such as steel, aluminum or tin, and other suitable materials. The layers can be applied using a chemical application process, or a hot melt process. The thickness and density of the reinforcing layer(s) varies depending on the nature of the end-product.

A scrim can increase the strength of the multi-layer composite material. Suitable scrim is known in the art and available commercially, and may be a plastic material such as nylon, or may be metallic, for example, steel, aluminum or tin. Scrim may be either supplied to the process in which the multi-layer composite is formed in which case the scrim becomes an additional layer of the multi-layer nonwoven composite web. In another embodiment, the scrim may be adhered to the formed multi-layer composite web.

In addition to the characteristics imparted from the component layers of multi-layer nonwoven composite material of the present disclosure, other materials or additives, such as chemical or biological additives, can be applied to the finished composite material to achieve desired characteristics such as odor absorption, durability, stain resistance, etc.

Regenerated fibers may be preferably derived from post-industrial manufacturing sources such as preconsumer textile products produced from the apparel, carpet, furniture, and household goods industries. Processes are available and known in the industry for cutting and opening the scrap raw material to produce component fibers.

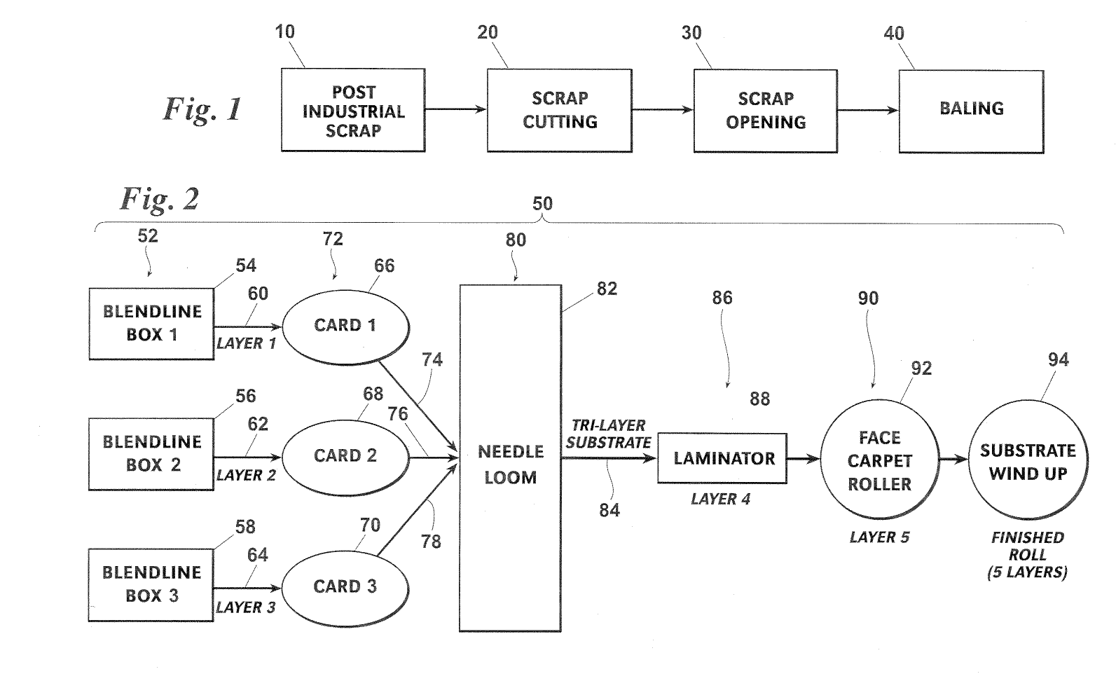

A conventional process for cutting and opening scrap textile fibers is depicted in FIG. 1. FIG. 1 depicts scrap 10 obtained from the post-industrial waste stream. Since scrap 10 is typically obtained from the producer/manufacturer, the component fibers of the textile scrap are known. The post-industrial scrap material may include synthetic, natural, and/or cellulosic fibers.

Post-industrial scrap 10 is first conveyed to scrap cutting station 20 where the scrap material is cut into small pieces. From there, the cut scrap is conveyed to an opening line where a series of rotary cutters or rotary pins successively pull apart the fabric until it is reduced to its constituent fibers.

From opening line 30, the opened fibers from the post-industrial scrap 10 are conveyed to a baling apparatus 40. Once cut and opened, the reclaimed post-industrial scrap fibers are baled for further processing.

The fibers which result from a conventional opening process are commonly stretched, twisted, and distorted which may result in weakening of the fibers. In addition, although an attempt is made to produce uniform fiber lengths, such attempts are relative and are generally within a range with an attempted average fiber length. Conventional cutting and opening processes also produce fibers which are frayed and include an end structure which is not cleanly cut resulting in pulled or trailing ends. With regard to synthetic fibers, as the cutting blades heat up as a result of friction and begin to become dull, the synthetic fiber ends tend to melt and/or fuse with adjacent fibers. All of these nonuniformities (damage) cause difficulty in processing the reclaimed fibers into usable and/or commercial products. Moreover, conventional opening processes have been found unsuitable for opening tightly woven fabrics such as cotton textiles.

A proprietary process for opening and cutting fibers from post-industrial scrap has been developed by Sustainable Solutions, Inc., Tulsa, Okla. By way of this process, opened and cut fibers can be obtained which are traceable to the originator of the post-industrial scrap as may be or become necessary as a result of legislation. When such traceable fibers are obtained, they are highly suited for use in the present process so that they can be traced through to the resultant composite web and thereon for further processing. In this way, the reclaimed fibers in the recycling stream are traceable to their origins.

If traceable fibers are obtained, those fibers can be tracked through the present process to the resultant composite web and products made therefrom. In this way, these fibers can be traced back to their source.

In the present process, according to the above, opened and cut cellulosic fibers from post-industrial scrap are obtained and separated according to constituent content. The desired opened and cut fibers are then ready for use in the process for manufacture of the multi-layer nonwoven composite material of the present disclosure.

Attention shall next be directed to FIG. 2 which depicts the preferred process for manufacture of a multi-layer nonwoven composite material of the present disclosure. In the manufacturing process 50 of the present disclosure, the three base layers are first produced.

In the preferred embodiment of the present disclosure, three base layers are included in the multi-layer nonwoven composite material disclosed herein. These three base layers of the preferred arrangement impart the characteristics of sound deadening, sound absorption, sound dispersion, and durability. It should be understood, however, that additional layers in the base layers are contemplated and could be added as additional characteristics are desired.

The three preferred base layers are produced separately beginning with a blending step 52. In the blending step 52, the respective constituent fibers of each base layer are blended at a plurality of blending stations 54, 56, and 58. In the preferred embodiment, blending stations 54, 56, and 58 of blending step 52 are a separate blendline box where blending step 52 is accomplished by separately mixing each of the constituent fibers. Although blendline boxes are preferred, it should be understood by those skilled in the art that other blending means could be employed, including but not limited to, bale breakers (for bales of constituent fibers) or feed boxes.

Following the blending step 52, the respective fibers which will form the base layers are then each respectively conveyed at 60, 62, and 64 to a respective carding station 66, 68, and 70 to form a constituent web in an aggregating step 72. These constituent webs will form the respective base layers of the multi-layer nonwoven composite material.

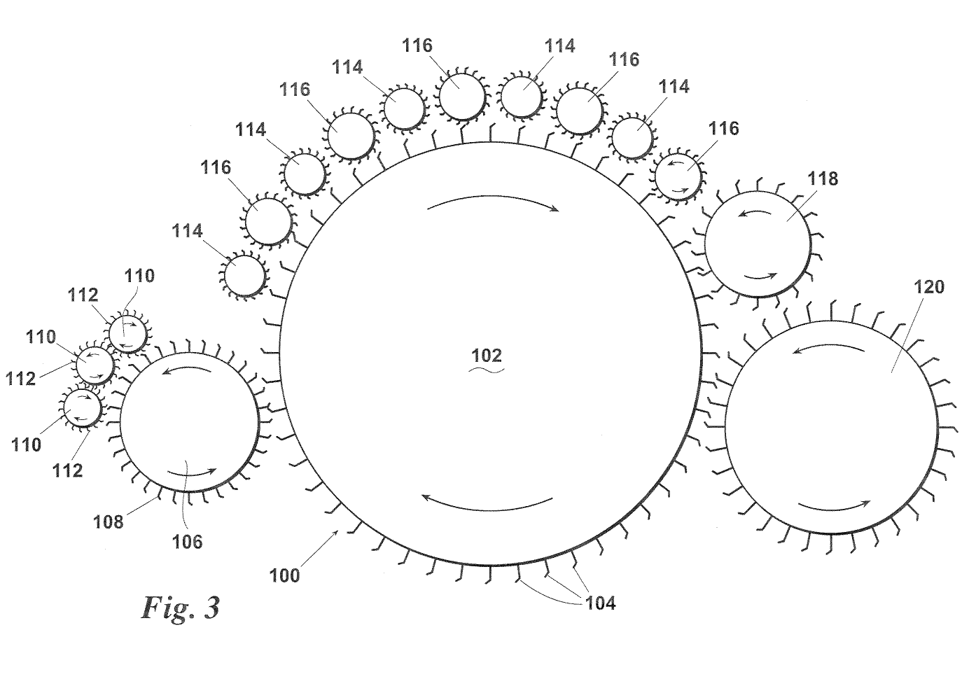

In the preferred embodiment, the constituent webs are formed at carding stations 66, 68, and 70 in aggregating step 72 using a carding apparatus. As would be apparent to one of ordinary skill in the art, a typical carding apparatus is depicted in FIG. 3. Carding generally includes, but without limitation, the taking of fibers, blending the fibers, the removal of impurities, and the formation of a web. The carding apparatus/machine can be of a revolving, revolving flat, stationary flat or workerstripper configuration known in the art. For example, in the revolving carding process of FIG. 3, a carding machine 100 utilizes opposed moving cards of closely spaced needles to pull and tease the constituent fibers apart. At the center of the carding machine is a large, rotating cylinder 102 covered with a card comprised of needles collectively 104 (which could also be wires, or fine metallic teeth) which are embedded in a heavy cloth or metal backing. This card is wrapped around cylinder 102. An opposing rotating cylinder 106 (or lickerin) including cards of needles 108 (wrapped on cylinder 106) rotates in the opposite direction of cylinder 102. The tips of the needles of the two opposing surfaces are angled in opposite directions and may rotate at different speeds. Cylinder 106 deposits the constituent fibers onto the needles 104 of the card of cylinder 102.

Carding machine 100 may also include means to carry the opened and cut fibers onto cylinder 102 where the carding takes place. Feeder cylinders 110 act to feed the opened and cut fiber 112 conveyed from the blendline box to cylinder 106 which is engaged by needles 108 and deposited onto needles 104 of cylinder 102.

Several pairs of cylinders each including a worker 114 and stripper 116 are positioned around the circumference of cylinder 102 and rotate in a direction opposite cylinder 102. The tips of the needles on the worker cylinders point in a direction opposite the needles on the stripper cylinders. Clumps of opened and cut fibers 112 deposited onto needles 104 of cylinder 102 are carried between the needles 104 of cylinder 102 and the cards of needles of worker cylinder 114. Carding takes place between the cards of needles of cylinder 102 and the cards of needles of worker cylinder 114. The clumps of opened and cut fibers are separated into individual fibers which are aligned in the direction of rotation of cylinder 102 as each fiber is theoretically held by individual needles from the two cards. The fibers engage each other randomly and form a coherent constituent web at and below the surfaces of the needles. The cards of needles on the stripper cylinders removes (strips) the formed constituent web of fibers from the worker cylinders 114 and deposits the constituent web onto the cards of needles of cylinder 102.

Following the operation of the worker cylinders 114 and stripper cylinders 116, a fancy cylinder 118 is positioned around the circumference of cylinder 102. Fancy cylinder 118 rotates in a direction opposite to that of cylinder 102 and acts to give loft to the constituent web carried by the cards of needles 104 of cylinder 102.

Other mechanical means remove the constituent web from the card of needles 104 of cylinder 102. This is accomplished by a doffer cylinder 120 positioned around the circumference from fancy cylinder 118 in the direction of rotation of cylinder 102. Doffer cylinder 120 includes a card of needles, the tips of which are oriented in a direction opposite the direction of the tips of needles 104 of cylinder 102. Doffer cylinder 120 rotates in a direction opposite the direction of cylinder 102 such that its card of needles removes, or doffs, the constituent web from the needles 104 of cylinder 102.

The doffed constituent web is deposited onto a moving belt where it can be conveyed to a combining station and combined with other constituent webs formed by other carding machines (three total in the preferred embodiment) at respective carding stations and conveyed to a combining station. Referring back to FIG. 2, constituent webs 74, 76, and 78 (formed in aggregating step 72) are conveyed from their respective carding stations 66, 68, and 70 to combining station 82. The respective constituent webs are combined in a combining step 80 at combining station 82 into a multi-layer (or tri-layer in the preferred arrangement) substrate 84.

In the preferred arrangement, combining step 80 is accomplished through the use of a needle loom at combining station 82. Needle looms, or needle punch looms are known in the art for use in combining multi-layers of fabrics. The constituent webs 74, 76, and 78 are overlayed on one another in a desired construction. The placement of the layers in the multi-layer substrate 84 may be significant and affect the characteristics of the resulting multi-layer nonwoven composite material.

Referring to FIG. 2 in association with FIG. 4, the apparatus and process for the manufacture of multi-layer composite material of the present disclosure shall be described in greater detail. Layer 1 is created by feeding regenerated fibers stored in container 130 by a feeding apparatus 132 to a carding machine 134. Feeding apparatus 132 could include a blendline box such as described above but may also be a bail breaker or feed box, as are known in the art. Carding machine 134 produces a fibrous web. The fibrous web may be conveyed to a crosslapping machine 136 so as to crosslap the fibrous web into a batt of material or may be conveyed for layering. The number of layers or laps which constitute the batt is determined by the desired weight of the constituent web or layer.

The batt may then be conveyed from crosslapper 136 to a needle punch loom 138 where it is needle punched to form a constituent web such as constituent web 74.

In the same manner, and preferably at the same time in an inline process, layer 2 or constituent web 2 is produced from regenerated fibers in storage container 140 fed by feeder 142 to carding machine 144 to form a second fibrous web such as constituent web 76 described above. This constituent web of the second layer is or may be either conveyed to overlay the first layer or optionally fed through a crosslapper 146 where it is crosslapped and needle punched by a needle punch loom 148 before being conveyed to overlap constituent web 74.

Likewise, the third constituent web 78 is preferably formed at the same time by feeding regenerated fibers from a storage container 150 which is fed by a feeder 152 to carding machine 154 to form a fibrous or constituent web 78 of layer 3. As with constituent web 74, and 76, constituent web 78 may optionally be conveyed first to a crosslapper 156 and then to a needle punch loom 158 before being conveyed to overlay constituent web 76 which in turn overlays constituent web 74. The composite web is then conveyed to a needle punch loom 160 in combining step 80 at combining station 82 to produce multi-layer substrate 84. In the event that the multi-layer composite web 84 is comprised only of the three base layers, it may be conveyed to a finishing machine 162, and/or a brush or sculpturing machine 164 as is known in the art. Finishing machine 162, brush, and/or sculpting machine 164 act to impart a finished appearance to the top or third layer of the multi-layer composite material. Such finishing and sculpting could include imparting a smooth top layer for tactile purposes and/or oriented the surface fibers and/or producing a sculpted pattern as is desired and known in the art. In the event a face layer is to be applied, the multi-layer substrate is conveyed to adhesive station 88 where adhesive is applied which bonds the face layer to the multi-layer substrate 84 at a finishing station 91 to thus produce a multi-layer composite layer substrate of the present disclosure.

A barrier layer may be optionally included in the multi-layer composite. Such a barrier layer, such as a polymeric film, is preferably inserted between layer 2 and layer 3 and accomplished by unwinding a roll of the polymeric film on top of constituent web 76, or layer 2 at an unwinding station 166.

An antibacterial material may be applied to the constituent web preferably upon the top layer of composite web 84. The antibacterial material imparts antibacterial properties to the multi-layer composite web. A particularly stable antibacterial agent is an SDC based surface disinfectant such as available commercially from PURE Bioscience in El Cajon, Calif. In addition, an odor absorbent material may be applied to impart odor absorbing properties.

Referring back to FIG. 2, once the constituent webs 74, 76, and 78 are overlayed in the desired configuration, the constituent webs are needle punched to form multi-layer substrate 84. In the preferred process, constituent webs 74, 76, and 78 are needle punched at a density in the range of 100 to 1000 punches per square inch and a penetration through the constituent webs of from about ¼ inch to about ¾ inch depending upon the desired thickness of the multi-layer substrate 84.

Once multi-layer substrate 84 is formed from the three base layers, the multi-layer substrate 84 as adhesive (layer) may be applied at step 86. The multi-layer substrate is conveyed to an adhesive station 88 where an adhesive material is applied

In a particularly preferred arrangement, a barrier layer may be inserted between constituent webs 76 and 78 (layers 2 and 3). Such barrier materials include polymeric films in the form of water dispersed emulsions or solutions and solvent based solutions. These polymer emulsions are typically referred to as “latexes.” With regard to the present invention, the term “latex” refers very broadly to any aqueous emulsion of a polymeric material (or film).

Barrier materials used in the formation of the barrier layer of multi-layer composite material in the present disclosure are preferably of the type which are capable of bonding to the base layers. Most preferably these barrier materials comprise organic polymer materials which may be heat fused or heat cured at elevated temperatures to bind (bond) the component layers and to provide desired characteristics, such as hydrophobicity, moldability, fire retardancy or stability to the resultant multi-layer nonwoven composite web.

The barrier layer helps to bond the layers, and other ingredients in the composite material, and to provide fire retardancy, water repellence, strength and durability. The barrier materials include anionic, cationic, and non-ionic binders and are typically present in about 3 to about 50%, for example, between about 15 and about 35% by weight, on a dry weight basis.

Examples of suitable barrier materials include latexes, such as butadiene copolymers, acrylates, vinyl-acrylics, styrene-acrylics, styrene-butadiene, nitrile-butadiene, olefin containing polymers, e.g., vinyl acetate-ethylene copolymers, vinyl ester copolymers, halogenated copolymers, e.g., vinylidene chloride polymers. Latex binders, when used, can contain functionality. Any kind of latex can be used, although acrylics may be preferred because they tend to provide good heat and light stability. Natural polymers such as starch, natural rubber latex, dextrin, cellulosic polymers, and the like can also be used. In addition, other synthetic polymers, such as epoxies, urethanes, phenolics, neoprene, butyl rubber, polyolefins, polyamides, polyesters, polyvinylalcohol, and polyesteramides can also be used as suitable barrier materials.

Following laminating step 86, a face layer 92 is applied. Face layer 92 forms the fifth layer of the multi-layer nonwoven composite material in the preferred embodiment. An adhesive is applied which acts to bond or fuse face layer 92 to multi-layer substrate 84 to form a multi-layer nonwoven composite material 94 which may be rolled up for transport. The multi-layer nonwoven composite material 94 manufactured as disclosed herein has a benefit of reduced weight over conventional woven or composite nonwoven materials and is tuned for desired characteristics.

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the spirit of this invention as defined by the appended claims.

What is claimed is:

1. A multi-layer composite material, comprising:
a first layer including coarse denier nonwoven regenerated synthetic fibers;
a second layer including nonwoven microdenier regenerated synthetic fibers;
a third layer including a nonwoven blend of generated natural and synthetic fibers said first, second, and third layers being layered and combined to form a multi-layer composite material.

2. The multi-layer composite material of claim 1 wherein the fibers of each of said first, second, and third layers are selected to impart a property to the multi-layer composite material.

3. The multi-layer composite material of claim 2 wherein said fibers of said first layer are selected to impart a sound deadening property.

4. The multi-layer composite material of claim 2 wherein said fibers of said second layer are selected to impart a sound dispersing property.

5. The multi-layer composite material of claim 1 wherein said fibers of said third layer are selected to impart a sound absorption property.

6. The multi-layer composite material of claim 1 further comprising a barrier layer.

7. The multi-layer composite material of claim 6 wherein said barrier layer is latex.

8. The multi-layer composite material of claim 6 wherein said barrier layer is a flame retardant material.

9. The multi-layer composite material of claim 1 further including a face layer.

10. The multi-layer composite material of claim 2 further including additives imparting additional properties to the multi-layer composite material.

11. The multi-layer composite material of claim 1 wherein an antibacterial agent is applied to said third layer.
